(19) United States
(12) Patent Application Publication
(10) Pub. No.: US 2003/0003917 A1
(43) Pub. Date: Jan. 2, 2003

(54) Wireless communication system, apparatus and method for providing wireless communication within a building structure

(76) Inventors: Rich T. Copley, San Diego, CA (US); Fraser M. Clayton, San Diego, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/895,277

(22) Filed: Jun. 29, 2001

(51) Int. Cl. H04Q 7/20

(52) U.S. Cl. 455/444; 455/462

(57) ABSTRACT

A system, apparatus and method provides communication services to interior mobile stations within a building structure using a building interface station located at the building structure. The building interface station communicates with a base station using link frequencies and with interior mobile stations using a coverage frequency also used within a service coverage region of the base station for communication with exterior mobile stations. The building interface station communicates with one or more distribution stations using a distribution frequency. The distribution stations communicate with the interior mobile stations using the coverage frequency.

### BACKGROUND OF THE INVENTION

The invention relates in general to wireless communication and more specifically to a system, apparatus and method for providing wireless communication service within a building.

Communication systems provide a variety of voice, multimedia, data and other services to users. Several conventional communications systems provide wireless services to users through an infrastructure using an arrangement of base stations where each base station transmits and receives signals to and from one or more mobile stations. The quality of the communication links between the mobile stations and the base stations are effected by a variety of mechanisms. For example, obstacles within the communication area may cause interference and fading. Among other undesirable situations, these mechanisms result in noisy connections, limited data throughput, dropped calls and areas having extremely limited or no communication service.

Conventional systems are particularly limited in providing communications services within building structures. The configurations of buildings coupled with construction materials such as steel and concrete prevent uniform distribution of radio signals within buildings. Communication links between mobile stations within a building and an external base station are often susceptible to high losses, interference and fading. As a result, users within a building experience the problems discussed above.

One attempt to improve in-building wireless service includes installing base stations within the building and establishing wireless service coverage to various floors through cables or wires. A base station such as Base Transceiver Station (BTS) can be installed within a building and connected to an external network through copper wire or fiber optic cable. The radio frequency (RF) output of the base station is distributed throughout the building using a radiating cable or a distributed antenna infrastructure. Signals transmitted by the mobile stations are received at the base station through the passive cable infrastructure or antennas.

Conventional systems utilizing such an arrangement, however, have several drawbacks. Installation of these systems typically accounts for 60-80 percent of the total cost. In addition to routing cables on each floor, cables must be routed between floors often requiring expensive drilling and patching of fire barriers. Installation must typically occur at night resulting in premium labor and additional security costs. Further, conventional system implementation result in inefficient use of equipment since a sophisticated BTS is most often dedicated to an entire building and the full user capacity of the BTS is rarely needed.

Additional drawbacks result in systems where the signals are routed using RF cabling such as coaxial cables between the floors. The numerous couplings at each floor and high cable loss result in low power levels at the floors furthest from the base station. The power amplifiers of the base stations must be operated at high power in order to compensate for the losses. In addition, signals received from mobile stations on the remote floors experience low signal to noise ratios (SNR).

Other attempts at providing in-building wireless service include installing a broadband bidirectional amplifier (BDA) that communicates with an external BTS through a wireless communication channel and provides in-building coverage through a cabled antenna network. In addition to some of the drawbacks discussed above, these active cable systems have several limitations. For example, the BDA requires a high quality communication link to the external BTS often requiring careful alignment of antennas. Also, since the BDAs are typically installed near the highest point of the building, the signals from more than one BTS may reach the BDA. In addition to issues related to interference, small changes in antenna alignment or location often result in frequent handoffs between base stations as the system evaluates the various signals and revises the preferred BTS for establishing the communication link. For example, a user with a mobile station traveling on an upper floor of a building may pass through several coverage areas of several base stations due to the line of sight propagation of signals at the high altitude. As the user moves along the floor, the mobile station experiences frequent handoffs between base stations as a result of typical handoff procedures.

Therefore, there is a need for an efficient method, apparatus and system for providing uniform wireless service within a building structure.

### BRIEF DESCRIPTION OF THE DRAWINGS

FIG. 1 is a block diagram of a wireless communication system in accordance with an exemplary embodiment of the invention.

FIG. 2 is a block diagram of a building interface station having a horizontally polarized antenna for communicating with the distribution stations in accordance with the exemplary embodiment of the invention.

FIG. 3 is a block diagram of a building interface station having a single antenna for communicating with mobile stations and distribution stations in accordance with the exemplary embodiment of the invention.

FIG. 4 is a block diagram of a downstream frequency shifter suitable for use in the building interface station in accordance with the exemplary embodiment of the invention.

FIG. 5 is a block diagram of an upstream frequency shifter suitable for use in the building interface station in accordance with the exemplary embodiment of the invention.

FIG. 6 is a block diagram of a distribution station in accordance with the exemplary embodiment of the invention.

FIG. 7 is a block diagram of a downstream frequency shifter suitable for use in the distribution station in accordance with the exemplary embodiment of the invention.

FIG. 8 is a block diagram of an upstream frequency shifter suitable for use in the distribution station in accordance with the exemplary embodiment of the invention.

FIG. 9 is flow chart of a method of providing wireless service to interior mobile stations within a building structure in accordance with the exemplary embodiment of the invention.

FIG. 10 is a flow chart of a method of providing wireless service to interior mobile stations performed at the base interface station in accordance with the exemplary embodiment of the invention.

FIG. 11 is flow chart of a method of providing wireless service to interior mobile stations performed at the building interface station in accordance with the exemplary embodiment of the invention.

FIG. 12 is flow chart of a method of providing wireless service to interior mobile stations performed at the distribution station in accordance with the exemplary embodiment of the invention.

### DETAILED DESCRIPTION OF THE PREFERRED EMBODIMENTS

In accordance with an exemplary embodiment of the present invention, a method, apparatus and system provides uniform wireless service within a building structure. A building interface station provides a communication link between a base station and one or more distribution stations. In accordance with the exemplary embodiment, the distribution stations are located within the building structure and provide an interface between interior mobile stations within the building and the building interface station. Wireless distribution signals are exchanged between the building interface station and the distribution stations while corresponding wireless coverage signals are exchanged between the distribution stations and interior mobile stations. In the exemplary embodiment, the building interface station communicates with interior mobiles both directly and through the distribution stations. In the exemplary embodiment, therefore, the building interface station and the distribution stations form an in-building simulcast communication system with a wireless backhaul.

Installation costs are greatly reduced since the in-building wireless backhaul does not require the installation of involved cable networks as in conventional systems. The locations of the distribution stations can be strategically chosen to allow for uniform wireless service on a floor within the building.

As mentioned above, wireless service to interior mobile stations within a building structure is significantly less than optimum in conventional cellular systems. In conventional cellular communication systems, each of a plurality of cellular base stations provides wireless service to mobile stations within a base station coverage region in the vicinity of the cellular base station. The base station coverage regions are often partitioned into sectors, where a dedicated set of frequencies is used for communicating with mobile stations within the sector. A convenient frequency allocation plan includes partitioning the base station coverage region into three sectors and dedicating four frequencies for downstream communication and four frequencies for upstream communication per sector. Time division multiplexing (TDM) techniques are used to provide eight time slots per frequency where at least one time slot within a sector is reserved for control.

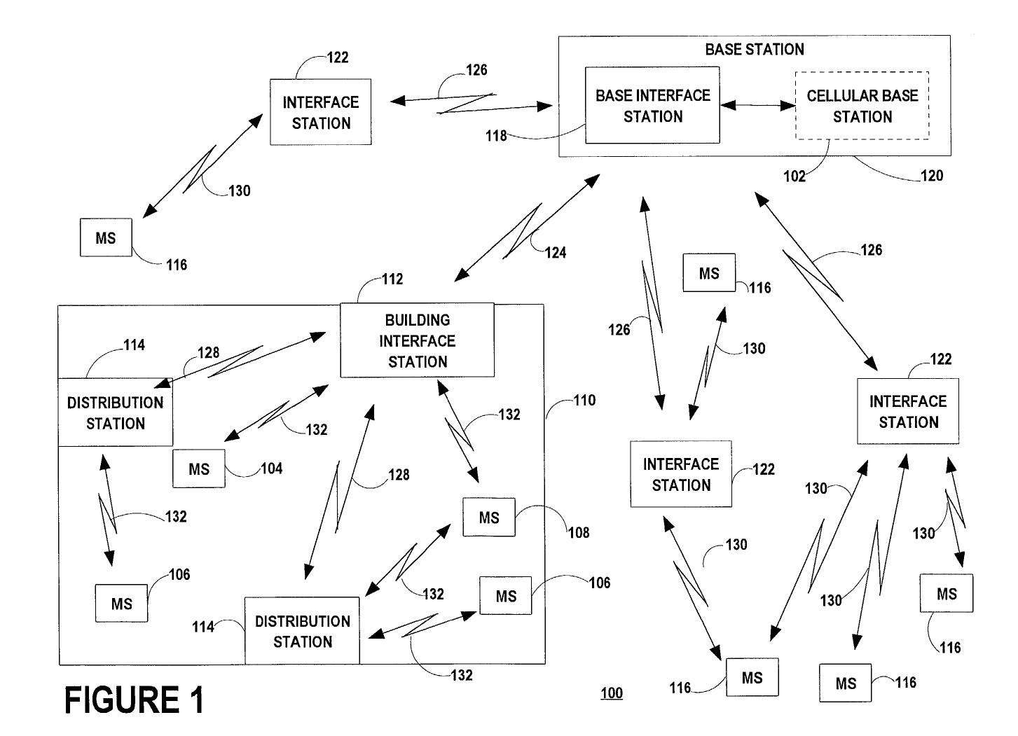

FIG. 1 is a block diagram of a wireless communication system 100 in accordance with the exemplary embodiment of the invention. Although the present invention may be utilized in accordance with a variety of communication systems, modulation techniques, and protocols, the wireless communication system 100 is implemented as part of a GSM cellular system. In the exemplary embodiment, the communication system 100 is integrated in accordance with an infrastructure having one or more interface stations 122 that communicate with the base interface station 118 to provide wireless service to mobile stations 116. Such an infrastructure is described in detail in U.S. Pat. No. 5,787,344 issued to Stefan Scheinert on Jul. 28, 1998, entitled “Arrangement of Base Transceiver Stations of an Area-Covering Network”, and is incorporated by reference herein. In the interest of brevity, therefore, only a general overview of a suitable infrastructure utilizing a plurality of interface stations 122 to provide wireless service to mobile stations 116 is discussed below.

In the exemplary embodiment, a base interface station 118 is connected to each cellular base station 102 of a cellular communication system. The base interface station 118 is connected to a cellular base station 102 that is part of a conventional GSM cellular system to form a base station 120. The cellular base station 102 is shown as a block having a dashed line to illustrate that the base station 120 may be single integrated unit. Therefore, the cellular base station 102 may be a separate device from the base interface station 118 or the base station 120 may be a single integrated unit having the functionality of the base interface station 118 and the cellular base station 102 as described herein. The cellular base station 102 is likely to be separate from the base interface station 118 where a simulcast communication system with interface stations 112, 122 is integrated with an existing cellular infrastructure and the base interface station 118 is connected to an existing cellular base station 102. Those skilled in the art, however, will recognize the various suitable configurations of the base interface station 118 and the cellular base station 102 and implementations of the base stations (102, 118, 120,) in accordance with the teachings herein. For example, the functionality of the base interface station 118 can be implemented in a cellular base station 102 by modifying a conventional cellular base station or manufacturing an integrated base station that functions as both a cellular base station 102 and a base interface station 118. Further, the base interface station 118 and the cellular base station 102 can be co-located or can be in different locations. In the exemplary embodiment, the base interface station 118 is connected to the cellular base station 102 through a coaxial cable. Communication and control signals, however, can be transmitted between the two units (102, 118) using a cable, radio frequency link, microwave link or any other type of wired or wireless communication channel.

Each cellular base station 102 communicates over a coaxial cable with the corresponding base interface station 118 using a set of communication frequencies allocated to the base station coverage region of the base station 102. The base interface station 118 communicates with several interface stations 122 within a sector over a link channel 126 using a set of link frequencies. The base station coverage regions of the base station 120 are partitioned into sectors, where a dedicated set of frequencies is used for communicating with mobile stations 116 within the sector. A suitable frequency allocation plan includes partitioning the base station coverage region into three sectors and dedicating four frequencies for downstream communication and four frequencies for upstream communication per sector. Time division multiplexing (TDM) techniques are used to provide eight time slots per frequency where at least one time slot within a sector is reserved for control and system management functions. Each of the interface stations 122 within a particular sector uses the set of coverage frequencies allocated to the particular sector to communicate with one or more mobile stations 116 over a coverage channel 130. In the exemplary embodiment, wireless service is not provided directly by the base station 120 to the mobile stations 116. Those skilled in the art will recognize that the frequency allocation scheme may be modified to meet the requirements of a particular base station coverage area.

In the downstream communication path, downstream information is transmitted at a downstream coverage frequency to the base interface station 118, frequency shifted to a downstream link frequency and transmitted to several interface stations 122 within a sector. Each of the interface stations 122 frequency shifts the received signals and transmits the downstream information at the appropriate downstream coverage frequency to one or more mobile stations 116 using simulcast techniques.

In the upstream direction, a mobile station 116 transmits upstream information to one or more exterior interface stations 122 at an upstream coverage frequency. Each exterior interface station 122 frequency shifts the received signal to an upstream link frequency and transmits the upstream information at the upstream coverage frequency to the base interface station 118. The base interface station 118 shifts the signal to an upstream coverage frequency and forwards the upstream signal to the cellular base station 102 where it is processed in accordance with conventional cellular communication techniques. Other details and advantages are further discussed in the referenced patent application.

In accordance with the exemplary embodiment of the invention, a building interface station 112 communicates with the base interface station 118 to provide wireless service to interior mobile stations 104-108 within the building structure. A wireless link channel 124 for communication between the base interface station 118 and the building interface station 112 uses frequencies different from the frequencies that are used to establish coverage channels 130 between the base station 120 and mobile stations 116 within the base station coverage region of the cellular base station 102. As described above, the cellular base station 102 communicates with the mobile stations 116 through the base interface station 118 in the exemplary embodiment. The base interface station 118 utilizes one or more frequencies within a frequency band typically dictated by a radio spectrum licensing authority such as the Federal Communications Commission (FCC). As is known, frequency allocation schemes that limit the use of particular base stations to a subset of the frequencies within the frequency band are typically used to maximize frequency reuse and efficiently use the available frequencies within the frequency band.

The building interface station 112 communicates with the distribution stations 114 through a wireless distribution channel 128 using one or more frequencies different from any frequency used in the interior coverage channel 132 for communicating with the interior mobile stations 104-108. The distribution stations 114 communicate with the interior mobile stations 106-108 on the inside of the building 110 through the interior coverage channel 132 using at least one frequency in common with the frequencies used in the exterior coverage channel 130. In the exemplary embodiment, however, the interior coverage channel 132 includes the same frequencies as the exterior coverage channel 130. In any particular situation, some interior mobile stations 104 may communicate exclusively with a building interface station 112 while other mobile stations 106 communicate exclusively through a distribution station 114. In other situations, an interior mobile station 108 may communicate both directly with the building interface station 112 and through one or more distribution stations 114. Therefore, downstream signals are simulcast at the downstream coverage frequency from the building interface station and one or more distribution stations 114. An upstream signal transmitted by an interior mobile station 108 is received through one or more distribution stations 114 and the building interface station 112.

The following upstream and downstream examples illustrate one suitable allocation of frequencies in accordance with the exemplary embodiment. In the following examples, frequencies are indicated by Fᵤₚ(x) and F_{dn}(x) where each value of x identifies a single frequency or set of frequencies independent and distinct from frequencies identified by any another value of x. Therefore, although the following examples refer to the frequencies as single frequencies, those skilled in the art will recognize that sets of frequencies can be chosen having the same relationships as single frequencies allowing for frequency management where the various signals can be transmitted on any one of frequencies within a frequency set. Fᵤₚ indicates an upstream frequency while F_{dn} indicates a downstream frequency. In systems using Time Division Multiple Access (TDMA) techniques such as Time Division Duplex (TDD), Fᵤₚ (x) may be the same single frequency as F_{dn} (x) for any given x. In Frequency Division Multiple Access (FDMA) and other systems, Fᵤₚ (x) does not represent a single frequency that is the same as a single frequency, F_{dn}(x), for any given x. The notation Fᵤₚ (x) for these systems identifies either a single frequency or set of frequencies that is/are different from a single frequency or set of frequencies identified by F_{dn} (x) for a particular x.

Downstream signals are processed and transmitted through the communication system 100 and received at the mobile stations 104-108. A signal that is to be transmitted to an interior mobile station 104-108 is received at the base interface station 118 from the cellular base station 102 at frequency F_{dn}(1). For this example, F_{dn}(1) can also be used by the base station 120 for communicating with the exterior mobile stations 116 within the cellular base station service region. In the exemplary embodiment, the downstream signal is transmitted as an RF signal having a frequency of F_{dn}(1) from the cellular base station 102 through a cable to the base interface station 118. The base interface station 118 frequency shifts the downstream signal from F_{dn}(1) to F_{dn}(2) where F_{dn}(2) is within the frequency band used by the communication system 100. The base interface station 118 transmits the resulting downstream link signal (at F_{dn}(2)) to the building interface station 112. The building interface station 112 frequency shifts the downstream link signal to another frequency, F_{dn}(3), that is within the frequency band but that is not the same as any frequency of the signals transmitted within the building structure 110.

The building interface station 112 transmits the resulting downstream distribution signal at F_{dn}(3) to one or more distribution stations 114 through the wireless distribution channel 128. The distribution station 114 shifts the distribution signal to F_{dn}(1) before transmitting the resulting downstream interior signal to the mobile station 106, 108. Therefore, the interior coverage signals transmitted within the interior wireless coverage channel 132 can have the same frequencies as the frequencies used by the wireless exterior coverage channel 130 within the base station coverage region used for communicating with the exterior mobile stations 116.

The building interface station 112 also frequency shifts the downstream link signal from F_{dn}(2) to F_{dn}(1) to form an interior downstream coverage signal in the exemplary embodiment. Interior mobile stations 104, 108 that are exposed to a suitable quality signal transmitted from the building interface station 112, directly receive interior downstream coverage signals at F_{dn}(1). An interior mobile station 108 may receive interior downstream coverage signals directly from the building interface station 112 and from one or more distribution stations 114. The interior downstream coverage signals, therefore, are transmitted using simulcast techniques.

An upstream interior signal is transmitted from the mobile station 106 at a frequency Fᵤₚ(1). After receiving the interior upstream coverage signal through the wireless channel 132, the distribution station 114 frequency shifts the signal from Fᵤₚ(1) to Fᵤₚ(3) to produce an upstream distribution signal. The upstream distribution signal is transmitted, at Fᵤₚ(3), to the building interface station 112.

The building interface station 112 frequency shifts the upstream distribution signal from Fᵤₚ(3) to Fᵤₚ(2) to produce an upstream link signal. The building interface station 112 transmits the upstream link signal, at Fᵤₚ(2), through the link channel 124 to the base interface station 118. The base interface station 118 frequency shifts the upstream signal to Fᵤₚ(1) which can be the same frequency as a frequency used by the exterior mobile stations 116 for transmitting signals to the base station 120. In the exemplary embodiment, the Fᵤₚ(1) is the same as the frequency (or frequencies) used by the exterior mobile stations 116 for transmitting signals to the base station 120.

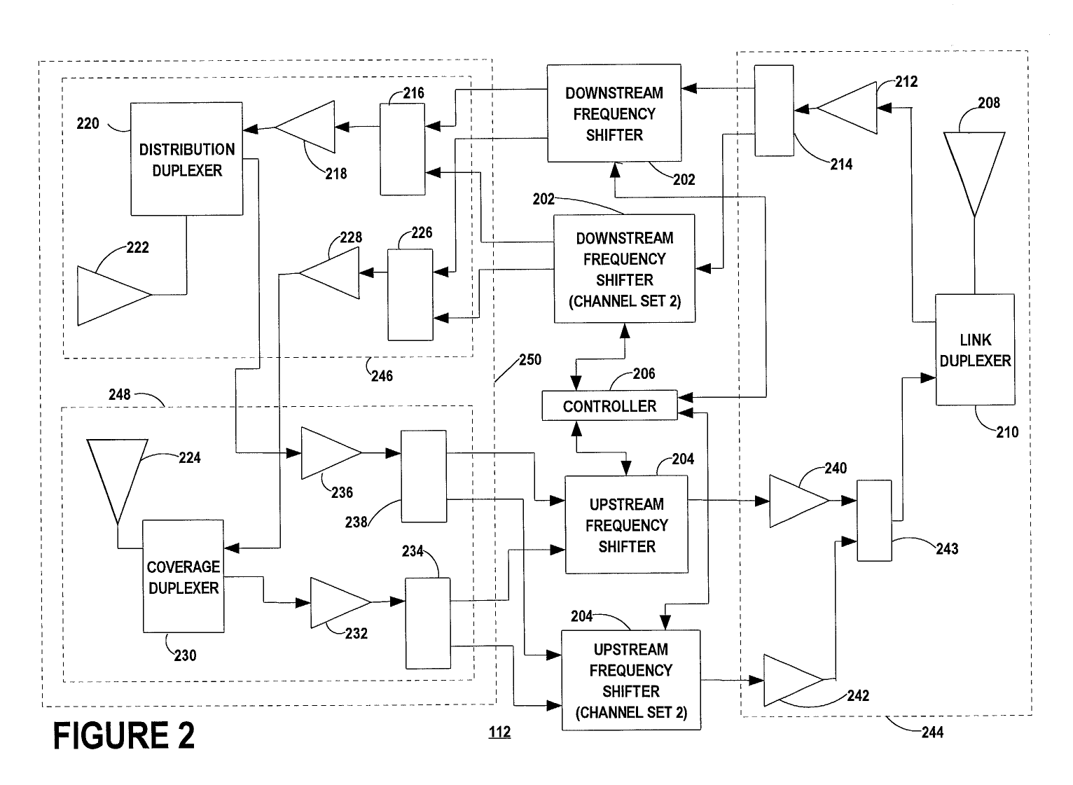

FIG. 2 is a block diagram of a building interface station 112 having a horizontally polarized antenna 222 for communicating with the distribution stations 114 in accordance with the exemplary embodiment of the invention. The functional blocks in FIG. 2 may be implemented using any combination of hardware, software or firmware. The building interface station 112 in the exemplary embodiment is configured to receive two downstream signals at two different frequencies and to transmit corresponding downstream signals at two distribution frequencies and at two coverage frequencies. FIG. 2 illustrates blocks for receiving and processing signals at two frequencies. Similar functional blocks for processing other signals at other frequencies can be connected to the blocks shown using splitters and combiners. The teachings herein can be expanded to implement a building interface station 112 capable of processing any number of signals or channels.

The building interface station 112 includes at least a link communication interface 244 for communicating through the wireless link channel 124 and an in-building communication interface 250 for communicating through the wireless distribution channel 128 and the interior wireless coverage channel 132. The block diagram of FIG. 2 illustrates a building interface station 112 where the in-building communication interface 250 includes a distribution communication interface 246 for communicating through the wireless distribution channel 128 and a coverage communication interface 248 for communicating through the wireless coverage channel 132. The functions of the communication interfaces 244-250 can be implemented using any combination of software, hardware and firmware. Exemplary implementations are discussed below. The blocks representing the communication interfaces 244-250 are shown using dashed lines to indicate that each of the communication interfaces (244-250) may include other functional blocks or portions of function blocks shown in FIG. 2. For example, some or all of the communication interfaces 244-250 may include portions of the frequency shifters 202, 204 or the controller 206.

The building interface station 112 includes a downstream frequency shifter 202 for each channel to frequency shift incoming downstream link signals to the interior coverage frequency and to the interior distribution frequency. An upstream frequency shifter 204 for each link channel 124 frequency shifts the interior upstream coverage signal and the upstream distribution signal to the upstream link frequency. Accordingly, each downstream link signal is frequency shifted to produce two signals at different frequencies and upstream signals received from both interior mobile stations 104-108 and distribution stations 114 are frequency shifted to the same corresponding upstream link frequency.

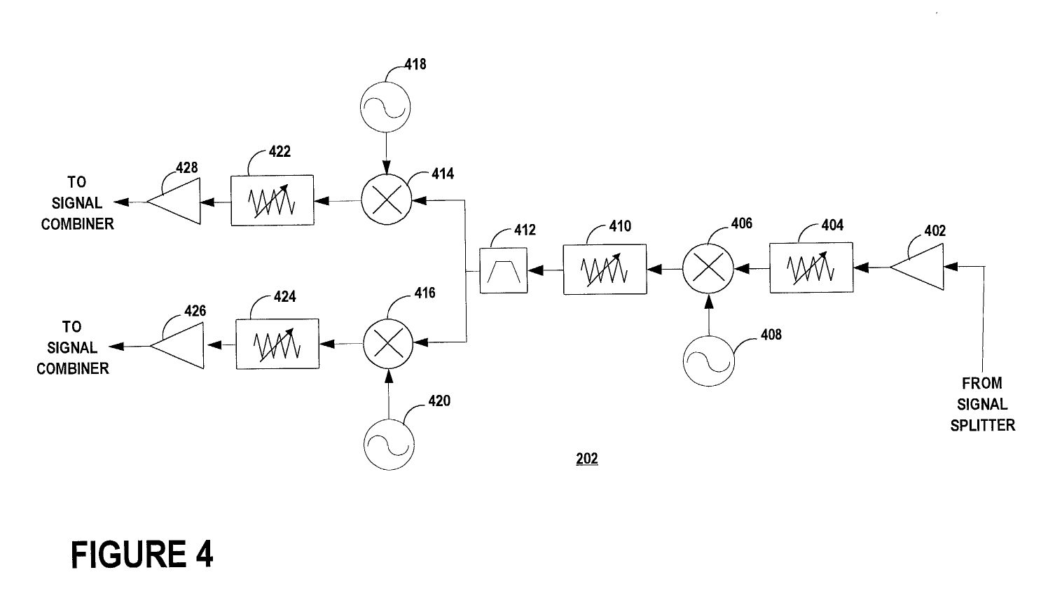

A controller 206 provides control signals to the frequency shifters 202, 204 as described below in reference to FIG. 4. In the exemplary embodiment, the controller 206 is a PC104 a microprocessor model number available from the JUMPtec® Industrielle Computertechnik AG company. The controller 206, however, may be any type of micro-processor, computer, processor, processor arrangement or processor combination suitable for implementing the functionality discussed herein. Software running on the controller 206 provides the various control functions and facilitates the overall functionality of the building interface station 112.

A downstream link signal transmitted from the base station 120 at the downstream link frequency is received through the link antenna 208. In the exemplary embodiment, the link antenna 208 is a directional antenna aligned to maximize the signal-to-noise ratio of signals transmitted between the base station 120 and the building interface station 112. Other types of antennas may be used and, in certain instances recognized by those skilled in the art, other types of antennas may be preferred.

In accordance with known techniques, a link duplexer 210 allows for the use of one link antenna 208 for receiving downstream link signals and transmitting upstream link signals. A Low Noise Amplifier (LNA) 212 amplifies the downstream link signal received through the link antenna 208 and the duplexer 210. Although several types of LNAs can be used to provide the appropriate gain and noise characteristics, an example of a suitable LNA 212 is the LP1500-SOT89, a PHEMT (Pseudomorphic High Electron Mobility Transistor) from Filtronic Solid-State, a division of Filtronic plc.

The amplified downstream link signal is received at the input of a signal splitter 214. In the exemplary embodiment, the signal splitter 214 has two outputs where the signals produced at each output have a power level that is approximately 3 dB lower than the power of the signal at the input. Although the signal splitter 214 may have any number of outputs, a suitable implementation includes a number of outputs in accordance with the number of downstream link signals that the building interface station 112 can receive. The signal produced at each output of the signal splitter 214 is received at a downstream frequency shifter 202.

As discussed in further detail below with reference to FIG. 4, the downstream frequency shifter 202 shifts the signal received at its input to both a downstream coverage frequency and a downstream distribution frequency. Each downstream frequency shifter 202 in the building interface station 112 shifts signals at a particular frequency of the downstream link channel 124 to a downstream coverage frequency and a downstream distribution frequency associated with a particular downstream link frequency. In the exemplary embodiment, therefore, the two downstream frequency shifters 202 shift each of the two downstream link signals to two downstream coverage frequencies and to two downstream distribution frequencies. The various frequencies of the channels can be changed by the controller 206. In the exemplary embodiment, the frequencies are configured at the time of system installation in accordance with the system frequency allocation scheme. The building interface station 112 can be configured, depending on the particular communication system 100, to dynamically adjust frequencies during operation of the building interface station 112 within the system 100.

The downstream distribution signals at the output of each downstream frequency shifter 202 are combined in a signal combiner 216 and amplified by an amplifier 218. A distribution duplexer 220 allows for downstream distribution signals and upstream distribution signals to be transmitted and received through the same distribution antenna 222. The distribution antenna 222 is a directional antenna, typically consisting of one or more patch antennas arranged in an array and is horizontally polarized in order to in increase isolation between the distribution signals and other signals present in the building structure 110. The distribution antenna 222, however, may have any one of several configurations or polarization. As discussed below with reference to FIG. 4, the functions of the distribution antenna 222 and the coverage antenna 224 can be combined in a single vertically polarized antenna.

The downstream coverage signal produced at the output of the downstream frequency shifter 202 is combined with the other downstream coverage signal from the other downstream frequency shifter 202 in a signal combiner 226. The combiner 226 includes at least one input for each downstream frequency shifter 202. The combined downstream signal is amplified in an amplifier 228 and transmitted through the coverage antenna 224. A coverage duplexer 230 allows the transmission and reception of downstream and upstream coverage signals through a single coverage antenna 224.

An LNA 232 amplifies the upstream coverage signals that are received through the coverage antenna 224 and the coverage duplexer 230. The amplified upstream coverage signal is received at an input of a signal splitter 234. In the exemplary embodiment, the signal splitter 234 has one output for each of the coverage channels and, therefore, has two outputs. The signal produced at each output of the signal splitter 234 is received at the input of each upstream frequency shifter 204.

An LNA 236 amplifies the upstream distribution signals that are received through the distribution antenna 222 and the distribution duplexer 220. The amplified upstream distribution signal is received at an input of a signal splitter 238. In the exemplary embodiment, the signal splitter 238 has one output for each of the coverage channels and, therefore, has two outputs. The signal produced at each output of the signal splitter 238 is received at the input of each upstream frequency shifter 204.

Each upstream frequency shifter 204 shifts the upstream coverage signal from the upstream coverage frequency to the upstream link frequency. The upstream distribution signal is shifted from the upstream distribution frequency to the upstream link frequency. The resulting upstream link signal, therefore, includes information transmitted directly from the interior mobile station 104, 108 through the coverage channel and information transmitted from the interior mobile station 106, 108 through the distribution station 114. When upstream signals are received through both the distribution channel and the coverage channel from a single interior mobile station 108, both signals are frequency shifted to the same upstream link frequency to form a combined upstream signal. Those skilled in the art will recognize that the characteristics of the combined signal waveform are similar to the characteristics of a signal received through a wireless channel having reflection and refraction due to obstacles. Accordingly, the upstream link signal can be received by the base interface station 118 in accordance with known techniques.

Each resulting upstream link signal is amplified in an amplifier 240, 242 and combined with the other resulting upstream signals from the other upstream frequency shifter 202 in the signal combiner 244. The combined signal, which includes upstream link signals at two different upstream link frequencies is transmitted through the link duplexer 210 and the link antenna 208.

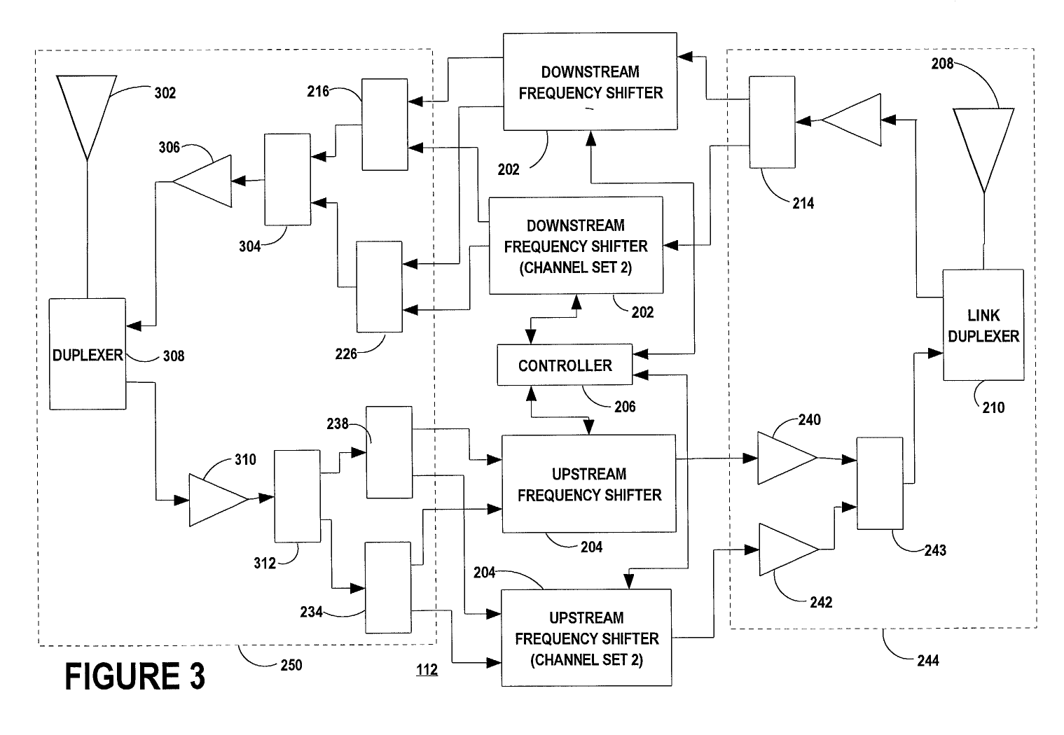

FIG. 3 is a block diagram of a building interface station 112 having a single antenna 302 for communicating with interior mobile stations 104, 108 and distribution stations 114 in accordance with the exemplary embodiment of the invention. Operation of the building interface station 112 illustrated in FIG. 3 is the same as the operation of the building interface illustrated in FIG. 2 except that both coverage signals and distribution signals are transmitted and received through a single vertically polarized antenna 302. Accordingly, the following discussion is focussed on the differences between the building interface stations 112 of FIG. 2 and FIG. 3. Although the building interface station 112 of FIG. 2 may be preferred for signal isolation characteristics, the building interface station 112 of FIG. 3 may have cost advantages. The use of the particular building interface station 112 or modification of the building interface stations 112 described herein depend on the particular communication system 100 factors readily recognized by those skilled in the art.

As discussed above, the downstream coverage signals produced at the output of each downstream frequency shifter 202 are combined in the signal combiner 226. The downstream distribution signals produced at the outputs of each downstream frequency shifter 202 are combined in the signal combiner. The combined downstream coverage signals and the combined downstream distribution signals are combined in a signal combiner 304 and amplified by an amplifier 306. Other combination and amplification techniques in accordance with known methods can be used to perform the desired result. For example, the signal combiners 216, 226, 304 may be replaced by a single signal combiner. A duplexer 308 allows the transmission of the distribution and coverage downstream signals as well at the reception of distribution and coverage upstream signals through the antenna 302.

The upstream distribution and coverage signals are amplified by an LNA 310, split into two signal sets by a signal splitter 312 and directed to splitters 234, 238. The splitters 234, 238 further split the signals to allow a sufficient signal power level at the input of each upstream frequency shifter 204. Other methods of splitting and amplifying the signals can be used to provide adequate signals to the upstream frequency shifters 204. For example, the signal splitters 234, 238, 312, can be replaced with a single signal splitter.

The various devices discussed above in reference to FIG. 2 and FIG. 3 are provided as examples and other devices and implementations will be readily apparent to those skilled in the art based on the teachings herein. The various functions of the blocks in FIG. 2 and FIG. 3 may be implemented in hardware, firmware, software or any combination thereof The functions may be combined or separated in accordance with known techniques. For example, any of the functionality described above may be implemented in a DSP, digital radio or otherwise using software, processors and other components based on these teachings and in accordance with known techniques.

In the exemplary embodiment, the building interface station 112 is located near a window to establish the highest quality communication link between the building interface station 112 and the base station 120. The size and weight of the exemplary building interface station 112 allows for mounting the building interface station on the inside surface of a window or wall of the building structure 110.

FIG. 4 is block diagram of a downstream frequency shifter 202 in accordance with exemplary embodiment of the invention. The downstream link signal is received at an input of an amplifier 402 and amplified. A variable attenuator 404 is adjusted to provide the appropriate power level of the downstream signal to a signal mixer 406. In the exemplary embodiment, analog power control signals generated by the controller 206 are received at a control inputs of the variable attenuators 410, 422, 424 in the downstream frequency shifter 202. Those skilled in the art will recognize the various techniques and devices that can be used to adjust the signal power level into the signal mixer 406.

The signal mixer 406 mixes the downstream signal with a mixing signal generated by an oscillator 408 to shift the downstream signal to an intermediate frequency (IF). The signal mixer 406 is a down-mixer and the IF is approximately 199 MHz in the exemplary embodiment. The IF, however, can be any suitable frequency chosen in accordance with known techniques and will depend on the particular communication system 100 requirements. In digital or software radio implementations the IF maybe zero or near zero.

The power level is adjusted by another attenuator 410 prior to filtering in a band-pass filter 412. The band-pass filter 412 is a Surface Acoustic Wave (SAW) filter having a bandwidth of approximately 0.2 MHz. Any one of several filters can be used and the filter selection depends on the type of system 100, bandwidth of the transmitted signal, the required Signal-to-Noise (SNR) ratio of the signals, the isolation required between link, coverage, and distribution frequencies, and several other factors recognized by those skilled in the art. The band-pass filter 412 attenuates signals outside the desired frequency bandwidth and allows the desired signals to pass to the distribution mixer 414 and coverage mixer 416.

In the exemplary embodiment, the oscillator 408 is controlled by the controller 206 and the frequency of the mixing signal can be changed to select the desired channel to be received. A suitable configuration of the mixer 406 and oscillator 408 includes using a voltage controlled oscillator (VCO) and setting the frequency of the mixing signal through a control signal produced by the controller 206.

The filtered IF signal produced at the output of the pass-band filter 412 is mixed with a mixing signal produced by the distribution oscillator 418 in the distribution mixer 414 to shift the downstream signal to the downstream distribution frequency. The coverage mixer 416 mixes the filtered IF signal with the mixing signal produced by the coverage oscillator 420 to shift the downstream signal to the downstream coverage frequency. The controller 206 provides control signals to the coverage oscillator 420 and distribution oscillator 418 to adjust the frequencies of the mixing signals to select the downstream coverage frequency and the downstream distribution frequency.

The power levels of the downstream distribution signal and the downstream coverage signal are adjusted in the corresponding attenuator 422, 424 and amplified in the corresponding amplifier 426, 428. The level of the signals, however, may be adjusted using any one of several known techniques.

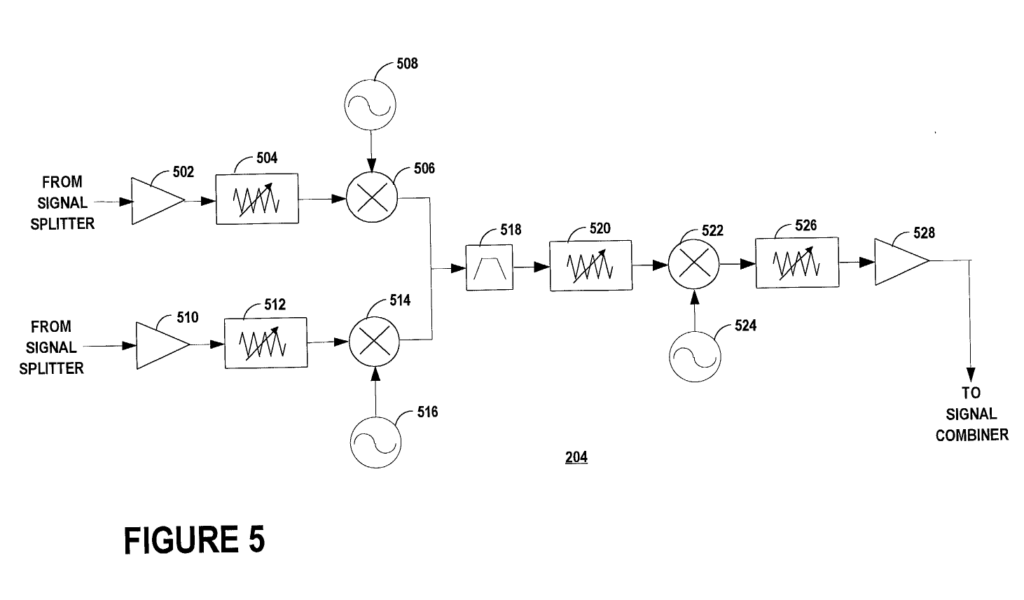

FIG. 5 is a block diagram of the upstream frequency shifter 204 in accordance with the exemplary embodiment of the invention. An amplifier 504 amplifies the upstream distribution signal. A variable attenuator 504 is adjusted to provide the appropriate power level of the upstream signal to an upstream distribution mixer 506. In the exemplary embodiment, analog power control signals generated by the controller 206 are received at control inputs of the variable attenuators 520, 526 in the upstream frequency shifter 204. Other techniques can be used to provide an upstream distribution signal with the appropriate power level to the upstream distribution mixer 506 and the upstream coverage mixer 514.

An oscillator 508 provides a mixing signal to the upstream distribution mixer 506 to shift the signal to an IF. The frequency of the mixing signal can be changed through by the controller 206 by adjusting a control signal presented to a control input of the oscillator 508. The frequency of the received upstream distribution signal, therefore, is determined by a control signal generated by the controller 206.

An amplifier 510 amplifies the upstream coverage signal. A variable attenuator 512 is adjusted to provide the appropriate power level of the upstream signal to an upstream coverage mixer 514.

An oscillator 516 provides a mixing signal to the upstream coverage mixer 514 to shift the signal to an IF. The frequency of the mixing signal can be changed by the controller 206 by adjusting a control signal presented to a control input of the oscillator 516. The frequency of the received upstream coverage signal, therefore, is determined by a control signal generated by the controller 206.

The IF signals produced by upstream coverage mixer 514 and the upstream distribution mixer 506 form an IF signal having characteristics similar to a signal transmitted through a wireless communication channel. As discussed above, an upstream signal may be received by a distribution station 114 and transmitted to the building interface station 112 as well as being received by the building interface station 112 directly from the mobile station 108 at the upstream coverage frequency. Both versions of the upstream signal are shifted to the same IF in the upstream frequency shifter 204. Those skilled in the art will recognize that the characteristics of the combined signal waveform at the IF are similar to the characteristics of a signal received through a wireless channel having reflection and refraction due to obstacles. Accordingly, after the IF signal is further processed in the upstream frequency shifter 204, shifted to the upstream link frequency and transmitted, the upstream link signal can be received by the base interface station 118 in accordance with known techniques.

The upstream IF signal is filtered by a band-pass filter 518 before being received at a variable attenuator 520. The band-pass filter 518 is a Surface Acoustic Wave (SAW) filter having a bandwidth of approximately 0.2 MHz. Any one of several filters can be used where the filter selection depends on the type of system 100, bandwidth of the transmitted signal, the required Signal-to-Noise (SNR) ratio of the signals, the isolation required between link, coverage, and distribution frequencies, and several other factors recognized by those skilled in the art. The band-pass filter 518 attenuates signals outside the desired frequency bandwidth and allows the desired signals to pass to the variable attenuator 520 and the upstream link mixer 522.

An oscillator 524 provides a mixing signal to the upstream link mixer 522 to shift the upstream IF filtered signal to the upstream link frequency. The frequency of the mixing signal can be changed by the controller 206 by adjusting a control signal presented to a control input of the oscillator 524. The frequency of the transmitted upstream link signal, therefore, is determined by a control signal generated by the controller 206. The power level of the upstream link signal is adjusted by a variable attenuator 526 and amplified by an amplifier 528.

The various devices discussed above in reference to FIG. 4 and FIG. 5 are provided as examples and other devices and implementations will be readily apparent to those skilled in the art based on the teachings herein. The various functions of the blocks in FIG. 4 and FIG. 5 may be implemented in hardware, firmware, software or any combination thereof The functions may be combined or separated in accordance with known techniques. For example, any of the functionality described above may be implemented in a DSP, digital radio or otherwise using software, processors and other components based on these teachings and in accordance with known techniques. Further, the upstream and downstream frequency shifter may implemented as single integrated circuit such as an Application Specific Integrated Circuit (ASIC), using discrete components or any combination thereof.

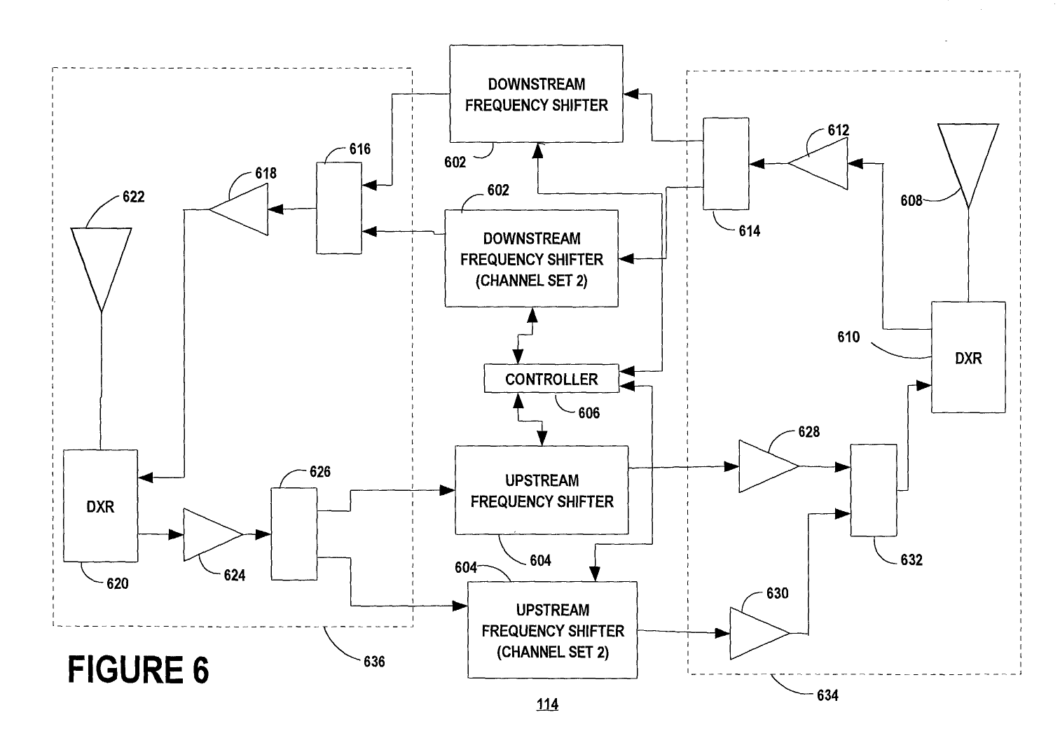

FIG. 6 is block diagram of a distribution station 114 in accordance with the exemplary embodiment of the invention. The functional blocks in FIG. 6 may be implemented using any combination of hardware, software or firmware. The distribution station in the exemplary embodiment is configured to receive two downstream distribution signals at two different frequencies and to transmit corresponding downstream coverage signals at two coverage frequencies. FIG. 6 illustrates blocks for receiving signals on two channels. The teachings herein can be expanded to implement a distribution station 114 capable of processing any number of channels. For example, in systems 100 where capacity and bandwidth are not threatened, a single downstream distribution channel and a single coverage channel can be used within a building 110.

The distribution station 114 includes at least a distribution communication interface 634 for communicating through the wireless distribution channel 128 and a coverage communication interface 636 for communicating through the interior wireless coverage channel 132. The functions of the communication interfaces 632, 634 can be implemented using any combination of software, hardware and firmware. Exemplary implementations are discussed below. The blocks representing the communication interfaces 634, 636 are shown using dashed lines to indicate that each of the communication interfaces (634, 636) may include other functional blocks or portions of function blocks shown in FIG. 6. For example, either or both of the communication interfaces 634, 636 may include portions of the frequency shifters 602, 604, or the controller 606.

The distribution station 114 includes a downstream frequency shifter 602 for each channel to frequency shift an incoming downstream distribution signal to the downstream coverage frequency. An upstream frequency shifter 604 for each coverage channel frequency shifts the upstream coverage signal from the upstream coverage frequency to the upstream distribution frequency to form the upstream distribution signal.

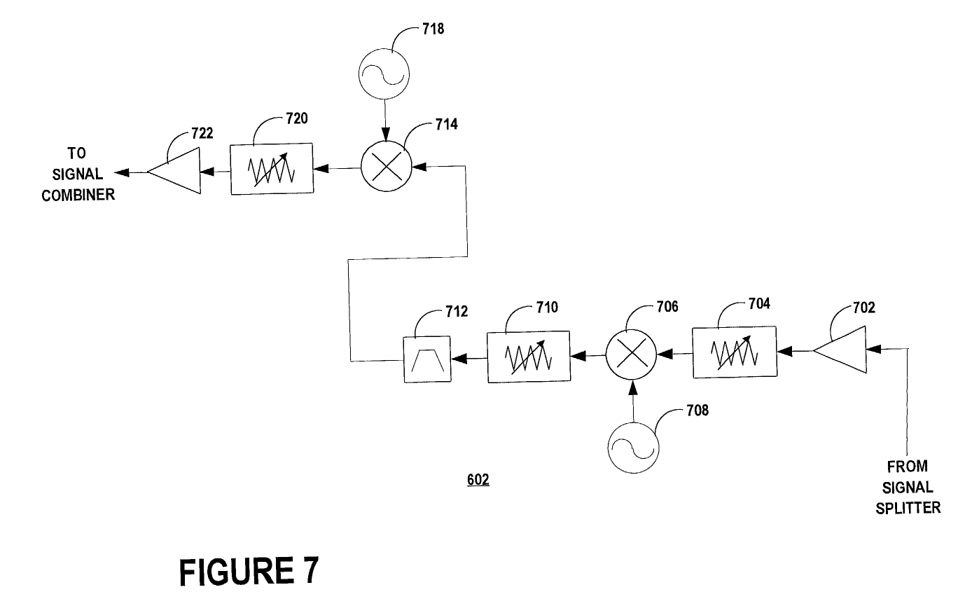

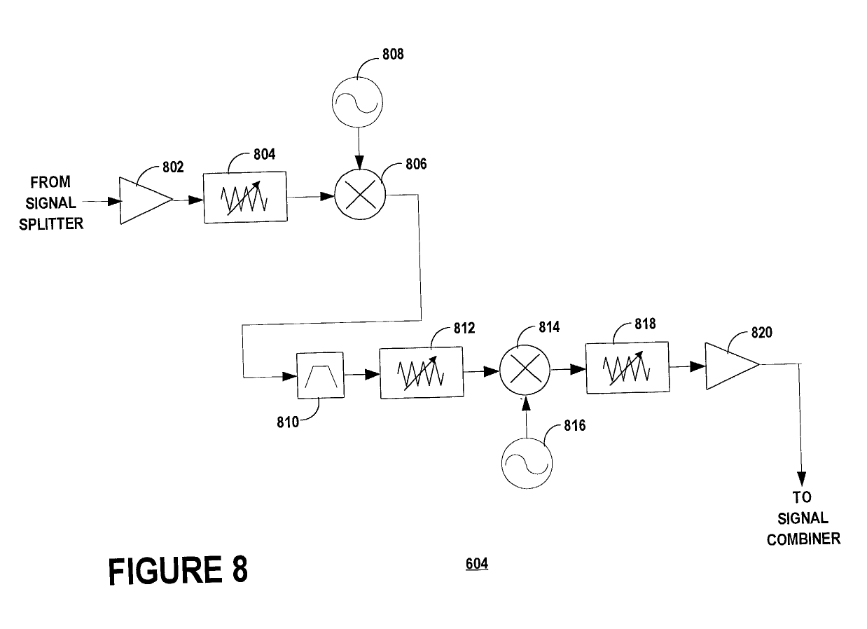

A controller 606 provides control signals to the frequency shifters 602, 604 as described below in reference to FIG. 7 and FIG. 8. In the exemplary embodiment, the controller 606 is a PC104 microprocessor available from JUMPtec® Industrielle Computertechnik AG. The controller 606, however, may be any type of micro-processor, computer, processor, processor arrangement or processor combination suitable for implementing the functionality discussed herein. Software running on the controller 606 provides the various control functions and facilitates the overall functionality of the distribution station 114.

A downstream distribution signal transmitted from the building interface station 112 at the downstream distribution frequency is received through the distribution antenna 608. In the exemplary embodiment, the distribution antenna 608 is a directional antenna aligned to maximize the signal-to-noise ratio of signals transmitted between the building interface station 112 and the distribution station 114. Other types of antennas may be used and, in certain instances recognized by those skilled in the art, other types of antennas may be preferred.

In accordance with known techniques, a duplexer 610 allows for the use of a single distribution antenna 608 for receiving downstream distribution signals and transmitting upstream distribution signals. A Low Noise Amplifier (LNA) 612 amplifies the downstream distribution signal received through the distribution antenna 608 and the duplexer 610. Although several types of LNAs 612 can be used to provide the appropriate gain and noise characteristics, an example of a suitable LNA 612 is the LP1500-SOT89 PHEMT (Pseudomorphic High Electron Mobility Transistor) from Filtronic Solid-State, a division of Filtronic plc.

The amplified downstream distribution signal is received at the input of a signal splitter 614. In the exemplary embodiment, the signal splitter 614 has two outputs where the signals produced at each output have a power level that is approximately 3 dB lower than the power of the signal at the input. Although the signal splitter 614 may have any number of outputs, a suitable implementation includes a number of outputs in accordance with the number of channels that the distribution station 114 can receive. The signal at each output is received at a downstream frequency shifter 602.

As discussed in further detail below with reference to FIG. 7, the downstream frequency shifter 602 shifts the signal received at its input to a downstream coverage frequency. Each downstream frequency shifter 602 in the distribution station 114 shifts signals at the particular frequency of the wireless distribution channel 128 to a downstream coverage frequency associated with the particular distribution frequency. In the exemplary embodiment, therefore, the two downstream frequency shifters 602 shift signals at two downstream distribution frequencies with the wireless distribution channel 128 to two downstream coverage frequencies within the wireless coverage channel 132. Although the various frequencies of the channels can be changed by the controller 606, the frequencies are configured at the time of system 100 installation in accordance with the system frequency allocation scheme in the exemplary embodiment. A suitable control technique includes the use of a wireless modem system connected to the controller 606 for channel and frequency management. The distribution station 114 can be configured depending on the particular communication system 100, to dynamically adjust frequencies during operation of the distribution station 114 with the system 100.

The downstream coverage signals at the output of each downstream frequency shifter 602 are combined in a signal combiner 616 and amplified by an amplifier 618. A coverage duplexer 620 allows for downstream coverage signals and upstream coverage signals to be transmitted and received through the same coverage antenna 622. The coverage antenna 622 is a vertically polarized directional antenna, such as the S1857AMP10SMF antenna from Cushcraft Communications. The coverage antenna 622, however, may have any one of several configurations or polarization depending on the particular communication system 100.

An LNA 624 amplifies the upstream coverage signals that are received through the coverage antenna 622 and the coverage duplexer 620. The amplified upstream coverage signal is received at an input of a signal splitter 626. In the exemplary embodiment, the signal splitter 626 has one output for each of the coverage channels and, therefore, has two outputs. The signals produced at each output of the signal splitter 626 are received at the input of each upstream frequency shifter 604. The upstream frequency shifter 604 shifts the upstream coverage signal from the upstream coverage frequency to the upstream distribution frequency.

As discussed in further detail below with reference to FIG. 8, the upstream frequency shifter 604 shifts the signal received at its input to the upstream distribution frequency. Each upstream frequency shifter 604 in the distribution station 114 shifts signals at the particular upstream coverage frequency of the wireless coverage channel 132 to an upstream distribution frequency associated with the particular coverage frequency. In the exemplary embodiment, therefore, the two upstream frequency shifters 604 shift two signals at two upstream coverage frequencies to two upstream distribution frequencies. The upstream coverage signals at the output of each upstream frequency shifter 604 are amplified by amplifiers 628, 630 and combined in a signal combiner 632 before transmission to the building interface station 112 through the duplexer 632 and the distribution antenna 610. In the exemplary embodiment, the distribution stations 114 are distributed along the floor of the building 110 and positioned to maximize the quality of the communication link between the distribution stations 114 and the building interface station 112, while establishing uniform wireless service to the mobile stations 104-108 on the floor.

FIG. 7 is a block diagram of a downstream frequency shifter 602 suitable for use in the distribution station 114. The downstream distribution signal is received at an input of an amplifier 702 and amplified. A variable attenuator 704 is adjusted to provide the appropriate power level of the downstream signal to a signal mixer 706. In the exemplary embodiment, analog power control signals generated by the controller 606 are received at a control inputs of the variable attenuators 704, 710, 720 in the downstream frequency shifter 602. Those skilled in the art will recognize the various techniques and devices that can be used to adjust the signal power level into the downstream signal mixer 706.

The signal mixer 706 mixes the downstream signal with a mixing signal generated by an oscillator 708 to shift the downstream signal to an intermediate frequency (IF). The signal mixer 706 is a down-mixer and the IF is approximately 199 MHz in the exemplary embodiment. The IF, however, can be any suitable frequency chosen in accordance with known techniques and will depend on the particular communication system 100 requirements. In digital and software implementation, the IF may be a very low value on zero.

The power level is adjusted by another attenuator 710 prior to filtering in a band-pass filter 712. The band-pass filter 712 is a Surface Acoustic Wave (SAW) filter having a bandwidth of approximately 0.2 MHz. Any one of several filters can be used where the filter selection depends on the type of system 100, bandwidth of the transmitted signal, the required Signal-to-Noise (SNR) ratio of the signals, the isolation required between coverage and distribution frequencies, and several other factors recognized by those skilled in the art. The band-pass filter 712 attenuates signals outside the desired frequency bandwidth and allows the desired signals to pass to the coverage mixer 714.

In the exemplary embodiment, the oscillator 708 is controlled by the controller 606 and the frequency of the mixing signal can be changed to select the desired channel to be received. A suitable configuration of the mixer 706 and oscillator 708 includes using a voltage controlled oscillator (VCO) and setting the frequency of the mixing signal through a control signal produced by the controller 606.

The filtered IF signal produced at the output of the band-pass filter 712 is mixed with a mixing signal produced by the coverage oscillator 718 in the coverage mixer 714 to shift the downstream signal to the downstream coverage frequency. The controller 606 provides a control signal to the coverage oscillator 718 to adjust the frequencies of the mixing signal to select the downstream coverage frequency.

The power level of the downstream coverage signal is adjusted in the attenuator 720 and amplified in the amplifier 722. The level of the signals, however, may be adjusted using any one of several known techniques.

FIG. 8 is a block diagram of an upstream frequency shifter 604 suitable for use in the distribution station 114. An amplifier 802 amplifies the upstream coverage signal. A variable attenuator 804 is adjusted to provide the appropriate power level of the upstream signal to an upstream distribution mixer 806. In the exemplary embodiment, analog power control signals generated by the controller 606 are received at a control inputs of the variable attenuators 704, 710 in the upstream frequency shifter 604. Other techniques can be used to provide an upstream coverage signal with the appropriate power level to the upstream coverage mixer 806.

An oscillator 808 provides a mixing signal to the upstream coverage mixer 806 to shift the signal to an IF. The frequency of the mixing signal can be changed by the controller 606 by adjusting a control signal presented to a control input of the oscillator 808. The frequency of the received upstream coverage signal, therefore, is determined by a control signal generated by the controller 606.

The upstream IF signal is filtered by a band-pass filter 810 before being received at a variable attenuator 812. The band-pass filter 810 is a Surface Acoustic Wave (SAW) filter having a bandwidth of bandwidth of approximately 0.2 MHz. Any one of several filters can be used and depends on the particular type of communication system 100, bandwidth of the transmitted signal, the required Signal-to-Noise (SNR) ratio of the signals, the isolation required between coverage and distribution frequencies. The band-pass filter 810 attenuates signals outside the desired frequency bandwidth and allows the desired signals to pass to the variable attenuator 812 and the upstream distribution mixer 814.

An oscillator 816 provides a mixing signal to the upstream distribution mixer 814 to shift the upstream IF filtered signal to the upstream distribution frequency. The frequency of the mixing signal can be changed by the controller 606 by adjusting a control signal presented to a control input of the oscillator. The frequency of the transmitted upstream distribution signal, therefore, is determined by a control signal generated by the controller 606. The power level of the upstream distribution signal is adjusted by a variable attenuator 818 and amplified by an amplifier 820.

The various devices discussed above in reference to FIG. 7 and FIG. 8 are provided as examples and other devices and implementations will be readily apparent to those skilled in the art based on the teachings herein. The various functions of the blocks in FIG. 7 and FIG. 8 may be implemented in hardware, firmware, software or any combination thereof The functions may be combined or separated in accordance with known techniques. For example, any of the functionality described above may be implemented in a DSP, digital radio or otherwise using software, processors and other components based on these teachings and in accordance with known techniques. Further, the upstream frequency shifter 604 and the downstream frequency shifter 602 may implemented as single integrated circuit such as an Application Specific Integrated Circuit (ASIC), using discrete components or any combination thereof.

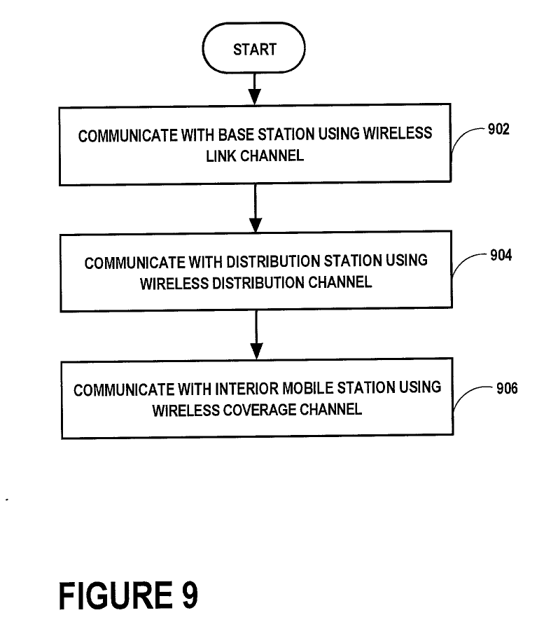

FIG. 9 is flow chart of a method of providing wireless service to interior mobile stations 104-108 within a building structure 110. In the exemplary embodiment, the steps are performed within the wireless communication system 100, where any step may be performed either partially or wholly within any one of the elements of the system 100.

At step 902, the base station 120 communicates using the wireless link channel 124. The base interface station 118 communicates with the building interface station 112 using one of more link frequencies. Upstream link signals are transmitted to the base station 120 and downstream link signal are received from the base station 120 at the building interface station.

At step 904, the building interface station 112 communicates with the distribution stations 114 over the distribution channel 128 using the distribution signals. The received link signals and received distribution signals are frequency shifted to the appropriate distribution and link signals, respectively, and transmitted.

At step 906, the interior mobile stations 104-108 communicate over the interior coverage channel 132 using at least one frequency in common with the coverage channel 130. The building interface station 112 transmits downstream coverage signals to the interior mobile stations 104, 108 and receives upstream coverage signals from the interior mobile stations 104, 108. The distribution stations 114 transmit downstream coverage signals to the interior mobile stations 106, 108 and receives upstream coverage signals from the interior mobile stations 106, 108.

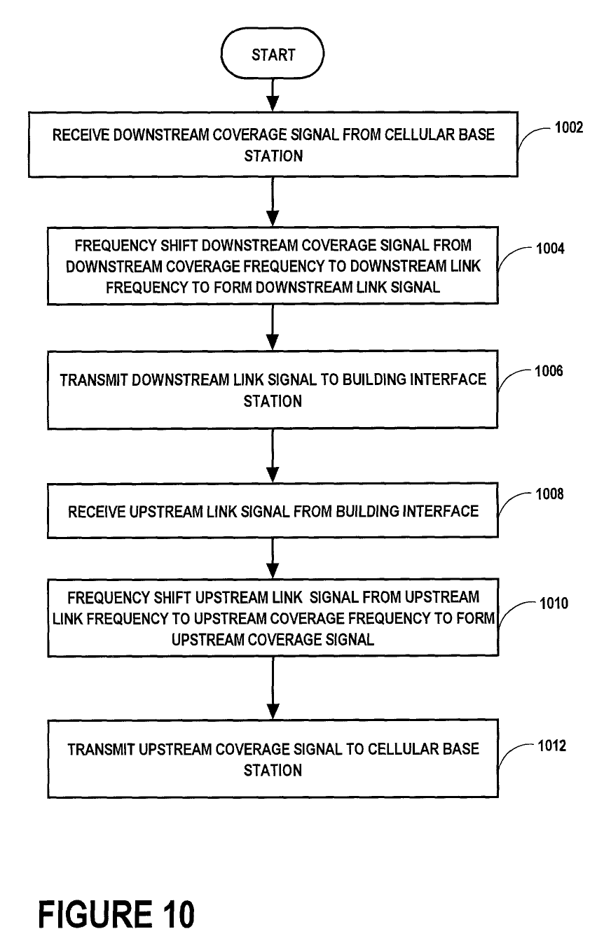

FIG. 10 is a flow chart of a method of providing wireless service to interior mobile stations 104-108 performed at the base interface station 118 in accordance with the exemplary embodiment of the invention. The method can be performed within the base station 120. As explained above, the base interface station 118 provides wireless communication service to mobile stations 116 outside of the building structure 110 through several interface stations 122 positioned within the base station coverage region. The various functions and steps for providing wireless service to exterior mobile stations 116 are discussed above and in the referenced U.S. Pat. No. 5,787,344. In the exemplary embodiment, the method performed in the base interface station 118 is implemented using hardware and software code running on a microprocessor or processor. Those skilled in the art will readily apply known techniques to the teachings herein implement the method in the base interface station 118 and/or base station 120.

At step 1002, the base interface station 118 receives a downstream coverage signal from a cellular base station 102 such as a BTS. As explained above, the signals between the base interface station 118 and the cellular base station 102 are exchanged over a coaxial cable connecting the two devices.

At step 1004, the base interface station 118 frequency shifts the downstream coverage signal from the downstream coverage frequency to the downstream link frequency to form the downstream link signal. In the exemplary embodiment, signal mixers and oscillators are used to shift the downstream coverage signal to an IF. The IF signal is filtered and shifted to the downstream link frequency using mixers and oscillators. The signals, however, can be processed and shifted using digital techniques.

At step 1006, the base interface station 118 transmits the downstream link signal to the building interface station 112 through the wireless link channel 124. The wireless link channel 124 utilizes one or more downstream frequencies and one or more upstream frequencies that are different from the coverage frequencies but are within the allocated frequency bandwidth for the system 100.

At step 1008, the base interface station 118 receives the upstream link signal from the building interface station through the wireless link channel 124.

At step 1010, the base interface station 118 frequency shifts the upstream link signal from the upstream link frequency to the upstream coverage frequency to form the upstream coverage signal. A suitable method of shifting the signal includes mixing the signal to an IF prior to mixing the resulting IF with an appropriate mixing signal using signal mixers and oscillators.

At step 1012, the base interface station 118 transmits the upstream coverage signal to the cellular base station 102. The base interface station 118 includes an amplifier and other appropriate hardware and software for transmitting the upstream coverage signal through the coaxial cable to the cellular base station 102.

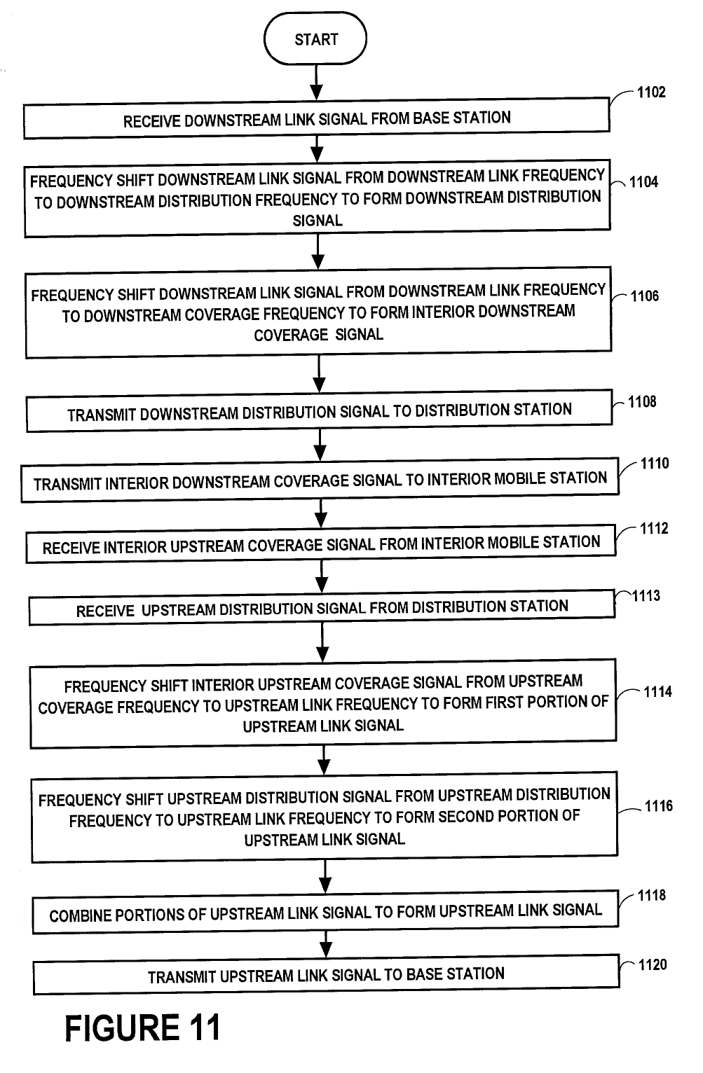

FIG. 11 is flow chart of a method of providing wireless service to interior mobile stations 104-108 performed at the building interface station 112. In the exemplary embodiment, the method performed in the building interface station 112 is implemented using hardware and software code running on a microprocessor or processor. The method can, for example be implemented on the controller 206 and hardware configuration discussed with reference to FIGS. 1-7. Those skilled in the art will readily apply known techniques to the teachings herein to implement the method in a variety of configurations of the building interface station 112. Steps 1102, 1104, 1114, 1116, 1118, and 1120 are examples of implementing step 902 of communicating with the base station 120. Steps 1106, 1110, 1112, and 1114 are examples of implementing step 906 of communicating with the interior mobile station 104, 108. Steps 1108, 1113 and 1116 are examples of implementing step 904 of communicating with the distribution station 114.

At step 1102, the building interface station 112 receives the downstream link signal from base station 120. A suitable method for receiving the signal includes using a link communication interface as discussed above.

At step 1104, the building interface station 112 frequency shifts the downstream link signal from downstream link frequency to the downstream distribution frequency to form the downstream distribution signal. A downstream frequency shifter 202 shifts the signal to the downstream distribution frequency. Signal mixers, oscillators, filters and other hardware as well as software can be used to mix the signal to an IF and to the downstream distribution frequency.

At step 1106, the building interface station 112 frequency shifts the downstream link signal from the downstream link frequency to the downstream coverage frequency to form the interior downstream coverage signal. A downstream frequency shifter 202 shifts the signal to the downstream coverage frequency. Signal mixers, oscillators, filters and other hardware as well as software can be used to mix the signal to an IF and to the downstream coverage frequency.

At step 1108, the building interface station 112 transmits the downstream distribution signal to the distribution station 114. The building interface station 112 transmits the interior downstream coverage signal to the interior mobile station 104, 108 at step 1110. The building interface station 112 includes amplifiers, duplexers, antennas and other hardware in the exemplary embodiment suitable for transmitting signals to the distribution station 114 and the interior mobile stations 104, 108.

At step 1112, the building interface station 112 receives the upstream coverage signal from the interior mobile station 104, 108. At step 1113, the building interface station 112 receives the upstream distribution signal from the distribution station 114. The building interface station 112 includes LNAs, duplexers, antennas and other hardware in the exemplary embodiment suitable for receiving signals from the distribution station 114 and the interior mobile stations 104, 108.

At step 1114, the building interface station 112 frequency shifts the interior upstream coverage signal from the upstream coverage frequency to the upstream link frequency to form a first portion of upstream link signal. An upstream frequency shifter 204 shifts the signal to the upstream link frequency. Signal mixers, oscillators, filters and other hardware as well as software can be used to mix the signal to an IF and to the upstream link frequency.

At step 1116, the building interface station 112 frequency shifts the upstream distribution signal from the upstream distribution frequency to the upstream link frequency to form a second portion of upstream link signal. The upstream frequency shifter 204 shifts the signal to the upstream link frequency. Signal mixers, oscillators, filters and other hardware as well as software can be used to mix the signal to an IF and to the upstream link frequency.

At step 1118, the building interface station 112 combines the portions of upstream link signal to form the upstream link signal. As explained above, the characteristics of the combined waveform are similar to a signal transmitted through a wireless channel experiencing signal reflection, refraction and fading.

At step 1120, the building interface station 112 transmits upstream link signal to the base station 102. Amplifiers 240, 242 an antenna 208, and other hardware allow for proper transmission of the link signal.

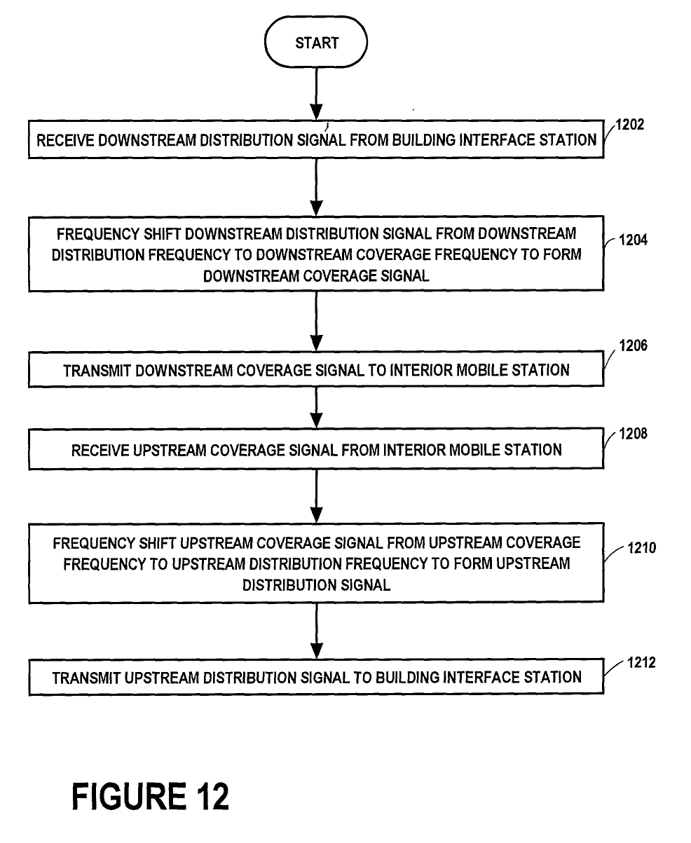

FIG. 12 is flow chart of a method of providing wireless service to interior mobile stations 106, 108 performed at the distribution station 114. At step 1202, the distribution station 114 receives the downstream distribution signal from the building interface station 112. In the exemplary embodiment, the downstream distribution signal is received through the distribution communication interface 634 that includes various receiver components as discussed above.

At step 1204, the distribution station 114 frequency shifts the downstream distribution signal from the downstream distribution frequency to the downstream coverage frequency to form the downstream coverage signal. As suitable method of shifting the signals includes using the downstream frequency shifter 602.

At step 1206, the distribution station 114 transmits the downstream coverage signal to the interior mobile station 106, 108. The coverage communication interface 636 provides suitable transmitter implementation for transmitting the downstream signals to the mobile stations 106, 108.

At step 1208, the distribution station 114 receives the upstream coverage signal from the interior mobile stations 106, 108. As discussed above, the coverage communication interface 636 provides a suitable receiver configuration for receiving the upstream signals from the mobile stations 106, 108.

At step 1210, the distribution station 114 frequency shifts the upstream coverage signal from the upstream coverage frequency to the upstream distribution frequency to form the upstream distribution signal. The upstream frequency shifter 604 is used to mix the upstream signals to an IF and from the IF to the upstream distribution frequency in the exemplary embodiment.

At step 1212, the distribution station 114 transmits the upstream distribution signal to the building interface station 112. The upstream distribution signals can be transmitted through the distribution communication interface 634.

Therefore, in the exemplary embodiment of the invention, wireless service to mobile stations 104-108 is provided through a communication system 100 utilizing a building interface station 112 and one or more distribution stations 114. Link frequencies are used to communicate through a wireless link channel 124 between the building interface station 112 and the base station 120. A wireless distribution channel 128 is used for communication between the distribution stations 114 and the building interface station 112 while a wireless coverage channel 132 using coverage frequencies is used for communicating between interior mobile stations 106, 108 and the building interface station 112 as well as the distribution station 114. The method, apparatus and system of the invention allows coverage frequencies used for providing wireless service to exterior mobile stations 116 to be re-used within a building structure 110.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

We claim:

1. A method of communication between a base station located outside of a building structure and an interior mobile station located inside the building structure, the method comprising:
communicating over a wireless link channel using a link frequency with the base station, wherein at least a portion of the building structure is contained within a base station coverage region using a wireless coverage frequency for communication with one or more exterior mobile stations located outside of the building structure; and
communicating over a wireless distribution channel using a distribution frequency with a distribution station within the building structure, the distribution station configured to communicate with the interior mobile station using the coverage frequency.

2. A method in accordance with claim 1, wherein the communicating over the wireless link channel comprises:
receiving a link signal at the link frequency from the base station.

3. A method in accordance with claim 2, further comprising:
frequency shifting the link signal to a distribution frequency to form a distribution signal.

4. A method in accordance with claim 3, wherein the communicating over the wireless distribution channel comprises:
transmitting the distribution signal to the distribution station.

5. A method in accordance with claim 1, wherein communicating over the wireless distribution channel comprises receiving a distribution signal from the distribution station at the distribution frequency.

6. A method in accordance with claim 5, further comprising:
frequency shifting the distribution signal to the link frequency to form a link signal.

7. A method in accordance with claim 6, wherein the communicating over the wireless link channel comprises:
transmitting the link signal to the base station.

8. A method in accordance with claim 1, wherein the communicating over the wireless link channel comprises:
receiving a downstream link signal at a downstream link frequency from the base station and transmitting an upstream link signal at an upstream link frequency.

9. A method in accordance with claim 8, wherein the communicating over the wireless distribution channel comprises:
receiving an upstream distribution signal from the distribution station at an upstream distribution frequency and transmitting a downstream distribution signal at a downstream distribution frequency to the distribution station.

10. A method in accordance with claim 9, further comprising:
frequency shifting the downstream link signal to the downstream distribution frequency to form the downstream distribution signal and frequency shifting the upstream distribution signal to the upstream link frequency to form the upstream link signal.

11. A method in accordance with claim 10, wherein the wireless link channel comprises a plurality of link frequencies including at least the upstream link frequency and the downstream link frequency.

12. A method in accordance with claim 1, further comprising:
communicating with the interior mobile station using the coverage frequency.

13. A method in accordance with claim 1, wherein the wireless coverage channel is established between the exterior mobile station and an exterior interface station communicating with the base station.

14. A method in accordance with claim 1, wherein wireless service is provided to exterior mobile stations within the base station coverage region through a plurality of interface stations communicating with the base station using the wireless link channel and communicating with the exterior mobile stations using the wireless coverage channel.

15. A method in accordance with claim 14, wherein the wireless link channel comprises a plurality of link frequencies and the wireless coverage channel comprises a plurality of coverage frequencies.

16. A method of communication between a base station located outside of a building structure and an interior mobile station located inside the building structure, the method comprising:
transmitting, from the base station, a downstream link signal to a building interface station;
frequency shifting, at the building interface station, the downstream link signal from the downstream link frequency to a downstream distribution frequency to form an downstream distribution signal;
transmitting the downstream distribution signal to a distribution station;
frequency shifting, at the distribution station, the downstream distribution signal to the downstream coverage frequency to form an interior downstream coverage signal;
transmitting the interior downstream coverage signal to the interior mobile station; and
transmitting an exterior downstream coverage signal at the downstream coverage frequency to an exterior mobile station within a base station service region.

17. A method in accordance with claim 16, further comprising:
frequency shifting, at the building interface station, the downstream link signal from the downstream link frequency to the downstream coverage frequency to form the interior downstream coverage signal; and
transmitting the interior downstream coverage signal from the building interface station to the interior mobile station.

18. A method in accordance with claim 16, further comprising:
receiving, at the distribution station, an interior upstream coverage signal from the interior mobile station;
frequency shifting the interior upstream coverage signal from an upstream coverage frequency to an upstream distribution frequency to form an upstream distribution signal;
transmitting the upstream distribution signal to the building interface station;
frequency shifting, at the building interface station, the upstream distribution signal from the upstream distribution frequency to an upstream link frequency to form an upstream link signal;
transmitting the upstream link signal to the base station; and
receiving, at the base station, an exterior upstream coverage signal at the upstream coverage frequency from the exterior mobile station.

19. A method in accordance with claim 18, further comprising:
receiving, at the building interface station, the interior upstream coverage signal;
frequency shifting, at the building interface station, the interior upstream coverage signal from the upstream coverage frequency to the upstream link frequency.

20. A method in accordance with claim 19, further comprising:
transmitting, from the base station, an exterior downstream link signal the exterior interface station;
frequency shifting, at the exterior interface station, the exterior downstream link signal to the downstream coverage frequency to form the exterior downstream coverage signal; and
transmitting the exterior downstream coverage signal to the exterior mobile station.

21. A method in accordance with claim 20, further comprising:
receiving, at the exterior interface station, an exterior upstream coverage signal from the exterior mobile station;
frequency shifting, at the exterior interface station, the exterior upstream coverage signal to an upstream link frequency to form an exterior upstream link signal; and
transmitting the exterior upstream link signal to the base station.

22. A method comprising:
communicating over a wireless distribution channel using a distribution frequency with a building interface station configured to communicate over a wireless link channel with an exterior base station located outside of a building structure;
communicating over a wireless coverage channel using a coverage frequency with an interior mobile station located inside the building structure, the coverage frequency used for communication with exterior mobile stations located outside the building structure and within a base station coverage region, wherein at least a portion of the building structure is contained within the base station coverage region.

23. A method in accordance with claim 22, wherein the communicating over the wireless distribution channel comprises receiving a downstream distribution signal from the building interface station, the downstream distribution signal corresponding to a downstream link signal transmitted from the base station.

24. A method in accordance with claim 23, further comprising:
frequency shifting the distribution signal from a distribution frequency to a coverage frequency to form a coverage signal.

25. A method in accordance with claim 24, wherein the communicating over the wireless coverage channel comprises:
transmitting the coverage signal to the interior mobile station.

26. A method in accordance with claim 22, wherein communicating over the wireless coverage channel comprises receiving a coverage signal from the interior mobile station at the coverage frequency.

27. A method in accordance with claim 26, further comprising:
frequency shifting the coverage signal to the distribution frequency to form a distribution signal.

28. A method in accordance with claim 27, wherein the communicating over the wireless distribution channel comprises:
transmitting the distribution signal to the base interface station.

29. A method in accordance with claim 22, wherein the communicating over the wireless distribution channel comprises:
receiving a downstream distribution signal at a downstream distribution frequency from the base interface station and transmitting an upstream distribution signal at an upstream distribution frequency.

30. A method in accordance with claim 29, wherein the communicating over the wireless coverage channel comprises:
receiving an upstream coverage signal from the interior mobile station at an upstream coverage frequency and transmitting a downstream coverage signal at a downstream coverage frequency to the interior mobile station.

31. A method in accordance with claim 30, further comprising:
frequency shifting the downstream distribution signal to the downstream coverage frequency to form the downstream coverage signal and frequency shifting the upstream coverage signal to the upstream distribution frequency to form the upstream distribution signal.

32. A method in accordance with claim 31, wherein the wireless distribution channel comprises a plurality of distribution frequencies including at least the upstream distribution frequency and the downstream distribution frequency.

33. A method in accordance with claim 22, wherein the wireless coverage channel is established between the exterior mobile station and an interface station communicating with the base station.

34. A method in accordance with claim 22, wherein wireless service is provided to exterior mobile stations within the base station coverage region through a plurality of interface stations communicating with the base station using the wireless link channel and communicating with the exterior mobile stations using the wireless coverage channel.

35. A method in accordance with claim 34, wherein the wireless link channel comprises a plurality of link frequencies and the wireless coverage channel comprises a plurality of coverage frequencies.

36. A system comprising:
a building interface station configured to communicate with a base station through a wireless link channel; and
a distribution station communicatively connected to the building interface station through a wireless distribution station, the distribution station configured to communicate with interior mobile stations within a building structure using a coverage frequency used for communication with exterior mobiles outside of the building structure and within a base station coverage region, wherein at least a portion of the building structure is within the base station coverage region.

37. A system in accordance with claim 36, further comprising:
a base station communicatively connected to the building interface station through the wireless link channel.

38. A system in accordance with claim 37, further comprising:
an interior mobile station communicatively connected to the distribution station through a wireless coverage channel using the coverage frequency.

39. A system in accordance with claim 38, further comprising:
a plurality of exterior interface stations communicatively connected to the base station, the exterior interface stations configured to communicate with the exterior mobile stations using the coverage frequency.

40. A system in accordance with claim 39, wherein the wireless link channel comprises a plurality of link frequencies and the wireless coverage channel comprises a plurality of coverage frequencies.

41. A system in accordance with claim 40, wherein the building interface station comprises:
a first communication interface configured to communicate through a wireless link channel with a base station; and
a second communication interface configured to communicate through a wireless distribution channel with a distribution station, the second communication interface further configured to communicate through a wireless coverage channel with mobile stations within a building structure using a coverage frequency used by exterior mobile stations outside of the building structure within a base station coverage region.

42. A system in accordance with claim 41, wherein the building interface further comprises:
a downstream frequency shifter configured to shift a downstream link signal received at the first communication interface to a downstream distribution frequency and to a downstream coverage frequency; and
an upstream frequency shifter configured to shift an upstream distribution signal received at the first communication interface and an upstream coverage signal to an upstream link frequency.

43. An apparatus in accordance with claim 42, wherein the first communication interface comprises:
an antenna configured to receive the downstream link signal and to transmit the upstream link signal.

44. An apparatus in accordance with claim 43, wherein the second communication interface comprises:
an antenna configured to receive the upstream coverage signal and the upstream distribution signal and configured to transmit the downstream coverage signal and the downstream distribution signal.

45. An apparatus in accordance with claim 44, wherein the second communication interface comprises:
a distribution communication interface configured to communicate through the wireless distribution channel with the distribution station; and
a coverage communication interface configured to communicate through the wireless coverage channel with mobile stations within the building structure using the coverage frequency.

46. An apparatus in accordance with claim 45, wherein the distribution communication interface comprises:
an antenna configured to receive the upstream distribution signal and to transmit the downstream distribution signal.

47. An apparatus in accordance with claim 45, wherein the coverage communication interface comprises:
an antenna configured to receive the upstream coverage signal and to transmit the downstream coverage signal.

48. A system in accordance with claim 41, wherein the distribution station comprises:
a distribution communication interface configured to communicate through a wireless distribution channel with a building interface station using distribution signals corresponding to link signals used for communication between the building interface station and a base station; and
a coverage communication interface configured to communicate through a wireless coverage channel with interior mobile stations within a building structure using a coverage frequency used by exterior mobile stations outside of the building structure within a base station coverage region of the base station.

49. A system in accordance with claim 41, wherein the distribution station further comprises:
a downstream frequency shifter configured to shift a downstream distribution signal received at the distribution communication interface to a downstream coverage frequency; and
an upstream frequency shifter configured to shift an upstream coverage signal to an upstream distribution frequency.

50. A system in accordance with claim 49, wherein the distribution station further comprises:
an antenna configured to receive the downstream distribution signal and to transmit the upstream distribution signal.

51. A system in accordance with claim 49, wherein the distribution station further comprises:
an antenna configured to receive the upstream coverage signal and to transmit the downstream coverage signal.

52. A building interface station.

53. An apparatus comprising:
a first communication interface configured to communicate through a wireless link channel with a base station; and
a second communication interface configured to communicate through a wireless distribution channel with a distribution station, the second communication interface further configured to communicate through a wireless coverage channel with mobile stations within a building structure using a coverage frequency used by exterior mobile stations outside of the building structure within a base station coverage region.

54. An apparatus in accordance with claim 53, further comprising:
a downstream frequency shifter configured to shift a downstream link signal received at the link communication interface to a downstream distribution frequency and to a downstream coverage frequency; and
an upstream frequency shifter configured to shift an upstream distribution signal received at the link communication interface and an upstream coverage signal to an upstream link frequency.

55. An apparatus in accordance with claim 54, wherein the first communication interface comprises:
an antenna configured to receive the downstream link signal and to transmit the upstream link signal.

56. An apparatus in accordance with claim 54, wherein the second communication interface comprises:
an antenna configured to receive the upstream coverage signal and the upstream distribution signal and configured to transmit the downstream coverage signal and the downstream distribution signal.

57. An apparatus in accordance with claim 54, wherein the second communication interface comprises:
a distribution communication interface configured to communicate through the wireless distribution channel with the distribution station; and
a coverage communication interface configured to communicate through the wireless coverage channel with mobile stations within the building structure using the coverage frequency.

58. An apparatus in accordance with claim 57, wherein the distribution communication interface comprises:
an antenna configured to receive the upstream distribution signal and to transmit the downstream distribution signal.

59. An apparatus in accordance with claim 57, wherein the coverage communication interface comprises:
an antenna configured to receive the upstream coverage signal and to transmit the downstream coverage signal.

60. A distribution station.

61. An apparatus comprising:
a distribution communication interface configured to communicate through a wireless distribution channel with a building interface station using distribution signals corresponding to link signals used for communication between the building interface station and a base station; and
a coverage communication interface configured to communicate through a wireless coverage channel with interior mobile stations within a building structure using a coverage frequency used by exterior mobile stations outside of the building structure within a base station coverage region of the base station.

62. An apparatus in accordance with claim 61, further comprising:
a downstream frequency shifter configured to shift a downstream distribution signal received at the distribution communication interface to a downstream coverage frequency; and
an upstream frequency shifter configured to shift an upstream coverage signal to an upstream distribution frequency.

63. An apparatus in accordance with claim 62, wherein the distribution communication interface comprises:
an antenna configured to receive the downstream distribution signal and to transmit the upstream distribution signal.

64. An apparatus in accordance with claim 62, wherein the coverage communication interface comprises:
an antenna configured to receive the upstream coverage signal and to transmit the downstream coverage signal.
